(19) United States
(12) Patent Application Publication
(10) Pub. No.: US 2015/0281290 A1
(43) Pub. Date: Oct. 1, 2015

(54) INTERNET PROTOCOL PHONE AND CALL FORWARDING METHOD

(71) Applicant: HON HAI PRECISION INDUSTRY CO., LTD., New Taipei (TW)

(72) Inventor: JIUN-SHIUNG LIAU, New Taipei (TW)

(21) Appl. No.: 14/485,439

(22) Filed: Sep. 12, 2014

(30) Foreign Application Priority Data
Mar. 28, 2014 (TW) 103111832

(51) Int. Cl. H04L 29/06

(52) U.S. Cl. CPC H04L 65/1096; H04L 63/06

(57) ABSTRACT

An Internet protocol (IP) phone which can remotely configure call forwarding in a distant IP phone requires the IP phone detecting a phone number of the distant IP phone and transmitting a first signal to the distant IP phone to request the distant IP phone to enable call forwarding mode. Upon the distant IP phone responding, the IP phone transmits a second signal including password to the distant IP phone to confirm that the distant IP phone has capabilities and has successfully enabled call forwarding mode. When the distant IP phone, responding to a correct password, makes a response the IP phone transmits a third signal to the distant IP phone to complete the call forwarding process.

### FIELD

The present disclosure generally relates to communications, and more particularly to Internet communications.

### BACKGROUND

When a local IP phone can not pick up a incoming call, or a user of the local IP phone does not want to pick up the incoming call, a function of call forwarding can forward the incoming call to a remote IP phone. Currently, call forwarding is based on inputting a phone number corresponding to the remote IP phone, then informing the call manager (CM) to forward the call to the remote IP phone. However, the function of call forwarding must be configured on the local IP phone, and the number of the remote IP phone must be known.

### BRIEF DESCRIPTION OF THE DRAWINGS

FIG. 1 illustrates a schematic diagram of an example embodiment of an application environment of an IP phone for configuring call forwarding.

FIG. 2 illustrates a schematic diagram of another example embodiment of an application environment of an IP phone for configuring call forwarding.

FIG. 3 illustrates a block diagram of an example embodiment of function modules of the IP phone.

FIG. 4 is a detailed transport diagram of the transmitting of the first signal.

FIG. 5 is a detailed transport diagram of the transmitting of the second signal.

FIG. 6 is a detailed transport diagram of the transmitting of the third signal.

FIG. 7 illustrates a flowchart of an example embodiment of a method for configuring call forwarding remotely.

### DETAILED DESCRIPTION

The embodiments are illustrated by way of example and not by way of limitation in the figures of the accompanying drawings in which like references numerals indicate similar elements. It should be noted that references to “an” or “one” embodiment in this disclosure are not necessarily to the same embodiment, and such references can mean “at least one.”

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

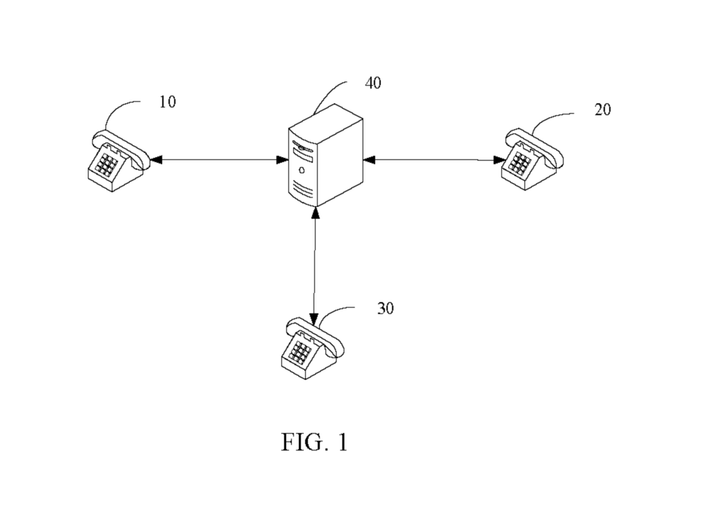

FIG. 1 illustrates an embodiment of an application environment of an IP phone 10 for configuring call forwarding. In the present embodiment, the IP phone 10, an IP phone 20 and an IP phone 30 are connected with each other through a call managing (CM) device 40. In the present embodiment, the IP phone 10, the IP phone 20, and the IP phone 30 have the same functions. In the present embodiment, the IP phone 10, the IP phone 20, and the IP phone 30 are in different locations. When the IP phone 30 calls the IP phone 20, and a user of the IP phone 20 is absent but close to the IP phone 10, the user of the IP phone 20 can configure the IP phone 20 for call forwarding utilizing the IP phone 10 so that the incoming call can be forwarded to the IP phone 10. In the embodiment, the incoming calls are made to the IP phone 30 and the IP phone 20.

In the present embodiment, the IP phone 10, the IP phone 20, and the IP phone 30 all have a function of Voice over Internet Protocol (VOIP) and a function of call forwarding. The CM 40 is a server which can manage the communication between the IP phones.

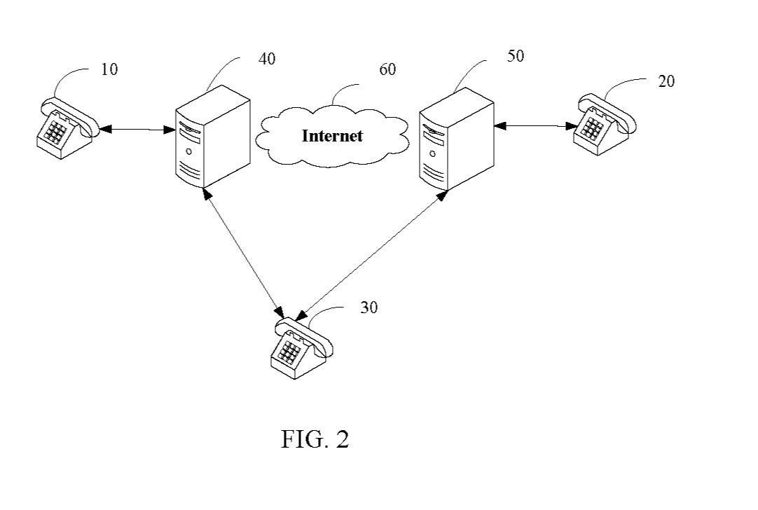

FIG. 2 illustrates another embodiment of an application environment of a IP phone 10 for configuring call forwarding. In the present embodiment, a difference between the application environment of FIG. 1 and the application environment of FIG. 2 is that the application environment of FIG. 2 has a CM 40 and a CM 50, connected with each other via an Internet 60.

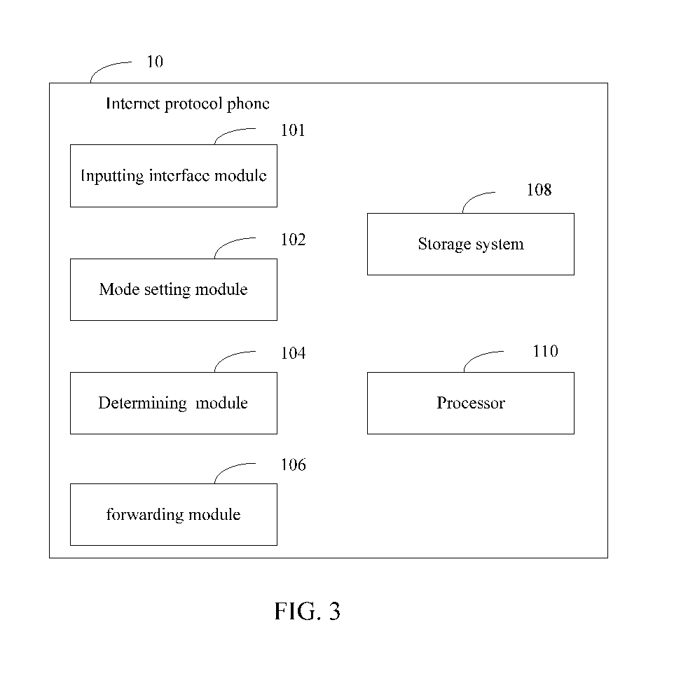

FIG. 3 illustrates an embodiment of function modules of the IP phone 10. In the embodiment, the IP phone 10 comprises an inputting interface module 101, a mode setting module 102, a determining module 104, a forwarding module 106, a storage system 108, and a processor 110.

The modules 101-106 can comprise one or more software programs in the form of computerized codes stored in the storage system 108. The computerized codes include instructions executed by the processor 110 to provide functions for the modules 101-106.

The inputting interface module 101 detects a phone number dialed by a user of the IP phone 10. In the present embodiment, dialing the phone number of the IP phone 20 can be by physical keys or by a touch screen on the IP phone 10.

The mode setting module 102 transmits a first signal to the IP phone 20 according to the phone number of the IP phone 20, to request the IP phone 20 to enable call forwarding mode. The mode setting module 102 receives a first response when the IP phone 20 has been configured into the mode of call forwarding.

When the first response has been received, the determining module 104 transmits a second signal to request confirmation that the IP phone 20 has capabilities and has successfully enabled call forwarding mode. When the IP phone 20 has capabilities and has successfully enabled call forwarding mode, the IP phone 20 will transmit a second response to IP phone 10.

The forwarding module 106 transmits a third signal comprising a phone number of the IP phone 10 to the IP phone 20, to forward calls made to the IP phone 20 to the IP phone 10 on condition that the IP phone 20 has capabilities and has successfully enabled call forwarding mode. In the present embodiment, once the IP phone 20 receives the third signal and becomes aware of a number phone of the IP phone 10, then the IP phone 20 can complete the call forwarding configuration from the IP phone 20 to the IP phone 10.

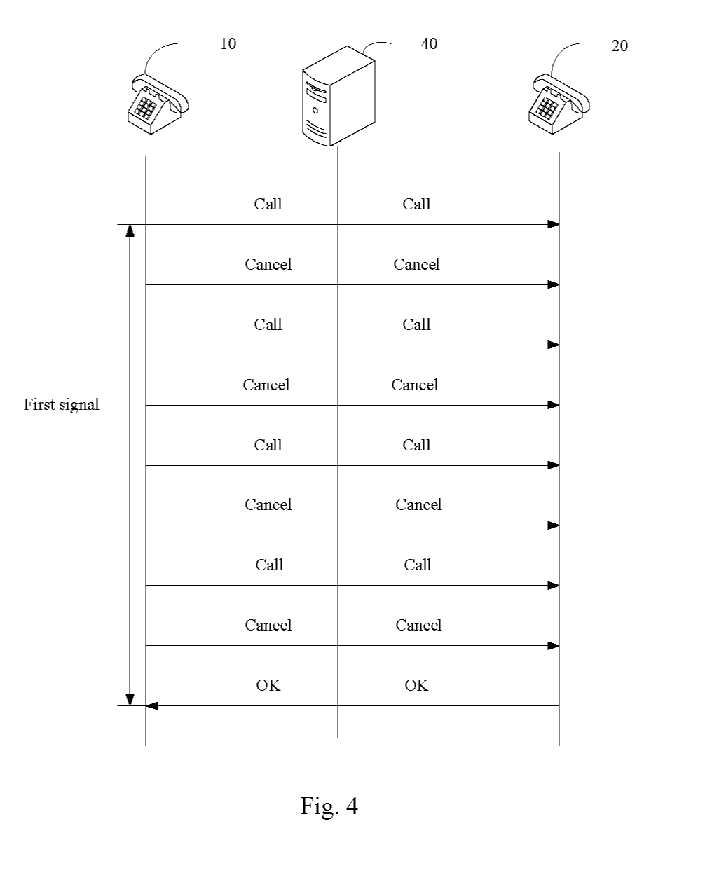

In the present embodiment, the first signal is a series of call and cancel demands during a certain time period which is defined by users, such as 4 seconds, and the call and cancel demands can configure the IP phone 20 into the mode of call forwarding. FIG. 4 shows the transmitting of the first signal. The IP phone 10 transmits four call and cancel demands to the CM 40 in four seconds, and the CM 40 transfers the call and cancel demands to the IP phone 20. When the IP phone 20 transitions into the mode of call forwarding, the IP phone 20 will return a first response to the IP phone 10, in the embodiment, the first response is a packet of data stating “OK.” The four call and cancel demands can be other quantity in other embodiment.

In the present embodiment, the second signal is multi-frequency tone which carries a security key, and the security key is used to determine whether or not the IP phone 20 permits call forwarding being set by the IP phone 10. In the present embodiment, the

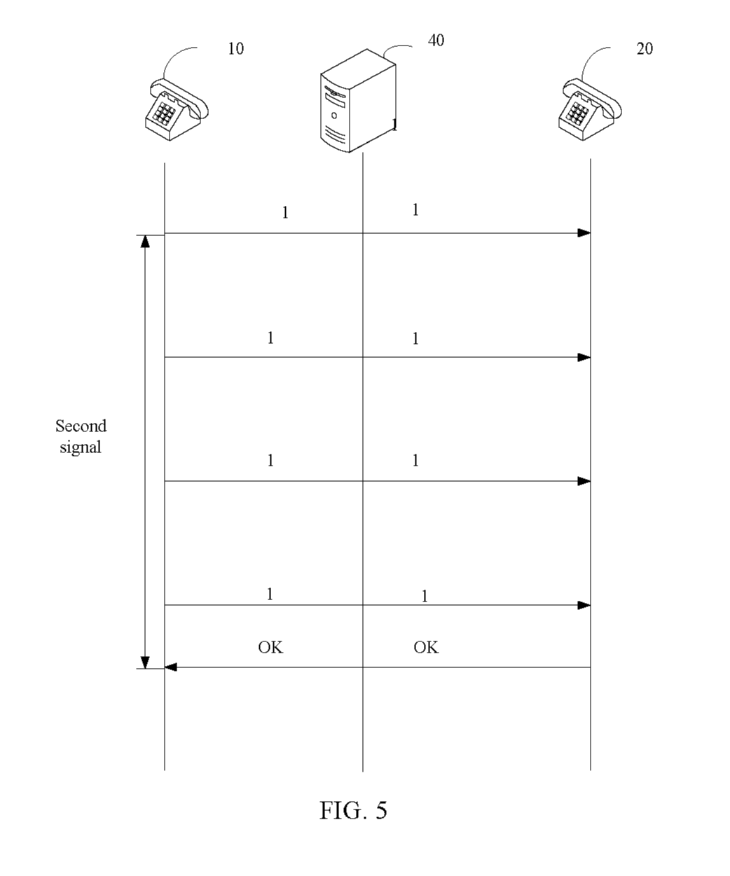

IP phone 20 will set a secret key, if the security key which is carried by the second signal matches the secret key, the IP phone 20 will permit call forwarding being set by the IP phone 10, otherwise the IP phone 20 will not permit such call forwarding. In the present embodiment, the security key carried in the second signal matches the secret key. FIG. 5 shows the transmitting of the second signal. In the present embodiment, the security key is 1111. As shown in FIG. 5, the IP phone 10 transmits the second signal to the CM 40, the CM 40 transfers the second signal to the IP phone 20, the IP phone 20 will then determine whether or not the IP phone 20 permits call forwarding being set by the IP phone 10 based on the secret key being matched by the security key in the second signal. In other embodiments, the user can set any preferred security key.

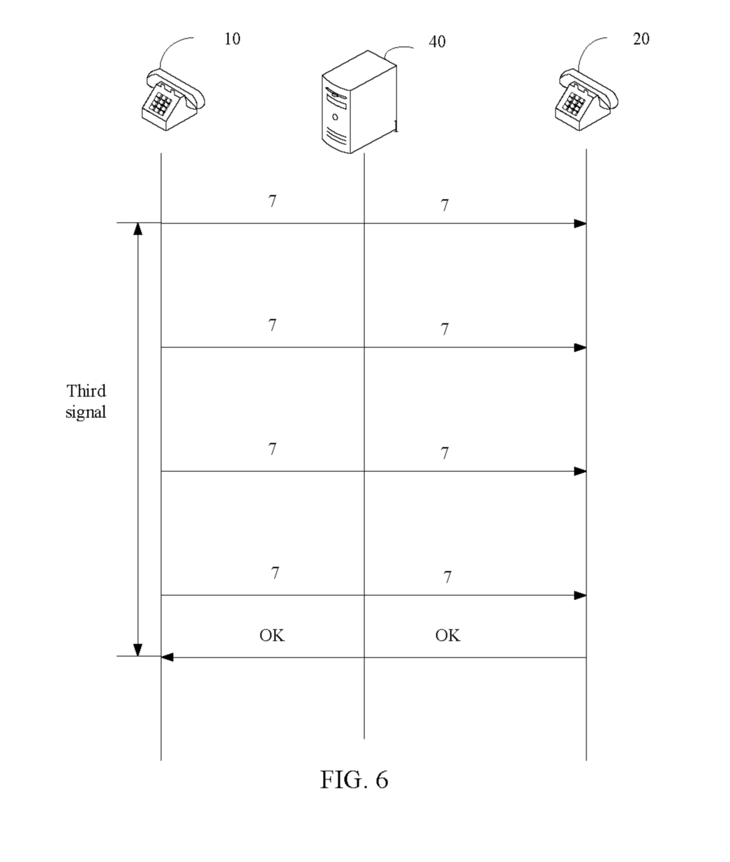

In the present embodiment, the third signal is also multi-frequency tone which carries the phone number of the IP phone 10. In the embodiment, if the IP phone 20 is otherwise able to forward the incoming call to the IP phone 10, the IP phone 20 must be aware of the phone number of the IP phone 10. FIG. 6 shows the transmitting of the third signal. The third signal carrying the phone number of the IP phone 10 is sent to the CM 40, and the CM 40 transfers the third signal to the IP phone 20, thus the IP phone 20 will receive the phone number of the IP phone 10 so that the IP phone 20 can carry out call forwarding from the IP phone 20 to the IP phone 10. In the embodiment, the phone number of the IP phone 10 is 7777.

In the present embodiment, the IP phone 10 and the IP phone 20 have same functions and can exchange roles in the application environment of FIG. 1. Thus an IP phone 10 taking the place of the IP phone 20, in the IP phone 20 location, can also receive the first signal, the second signal, and the third signal from an IP phone 20 and a call forwarding configuration of the IP phone 10 by the IP phone 20 can be carried out.

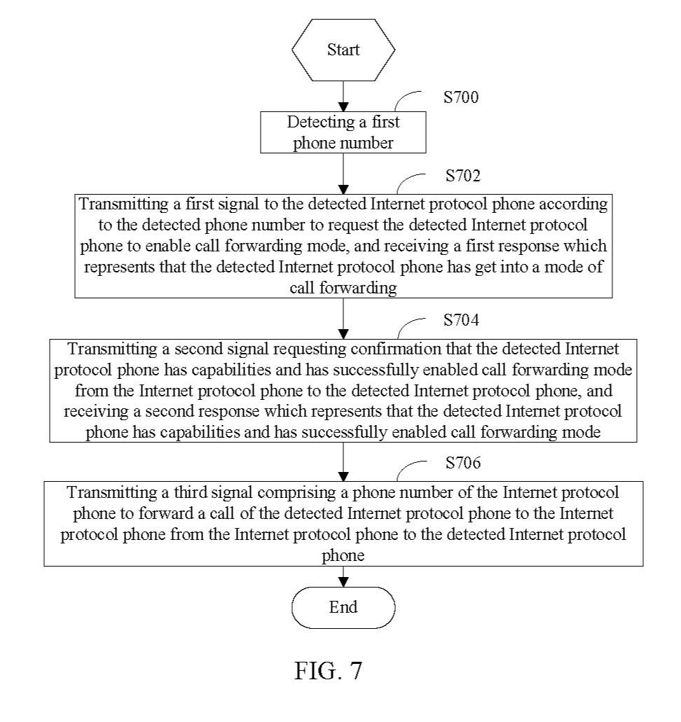

FIG. 7 illustrates a flowchart of an embodiment of configuring call forwarding remotely. In the embodiment, the method is implemented in the application environment shown in FIG. 1, in the following manner and as executed by the IP phone 10.

In block S700, the inputting interface module 101 detects a phone number dialed by a user of the IP phone 10. In the present embodiment, dialing the phone number of the IP phone 20 can be by physical keys or by a touch screen on the IP phone 10.

In block S702, the mode setting module 102 transmits the first signal to the IP phone 20 on condition that the phone number of the IP phone 20 has been received by the inputting interface module 101. The first signal request the IP phone 20 to enable call forwarding mode. The mode setting module 102 receives a first response when the IP phone 20 has been configured into the mode of call forwarding.

In the present embodiment, the first signal is a series of call and cancel demands during a certain time period which is defined by users, such as 4 seconds, and the call and cancel demands can configure the IP phone 20 into the mode of call forwarding. FIG. 4 shows the transmitting of the first signal. The IP phone 10 transmits four call and cancel demands to the CM 40 in four seconds, and the CM 40 transfers the call and cancel demands to the IP phone 20. When the IP phone 20 transitions into the mode of call forwarding, the IP phone 20 will return a first response to the IP phone 10, in the embodiment, the first response is a packet of data stating “OK.” The four call and cancel demands can be other quantity in other embodiment.

In block S704, when the first response has been received, the determining module 104 transmits a second signal to the IP phone 20 to confirmation that the IP phone 20 has capabilities and has successfully enabled call forwarding mode. The determining module 104 will receive a second response which is sent by the IP phone 20 when the IP phone 20 has capabilities and has successfully enabled call forwarding mode. In the embodiment, the second response from the IP phone 20 is also data packet indicating “OK.”

In the present embodiment, the second signal is multi-frequency tone which carries a security key, and the security key is used to determine whether or not the IP phone 20 permits call forwarding being set by the IP phone 10. In the present embodiment, the IP phone 20 will set a secret key, if the security key which is carried by the second signal matches the secret key, the IP phone 20 will permit call forwarding being set by the IP phone 10, otherwise the IP phone 20 will not permit such call forwarding. In the present embodiment, the security key carried in the second signal matches the secret key. FIG. 5 shows the transmitting of the second signal. In the present embodiment, the security key is 1111. As shown in FIG. 5, the IP phone 10 transmits the second signal to the CM 40, the CM 40 transfers the second signal to the IP phone 20, the IP phone 20 will then determine whether or not the IP phone 20 permits call forwarding being set by the IP phone 10 based on the secret key being matched by the security key in the second signal. In other embodiment, the user can set any preferred security key.

In block S706, after the IP phone 20 has sent the second “OK” response to IP phone 10 indicating that IP phone 20 permits call forwarding to be set remotely, then the IP phone 10 will call the IP phone 20 again and transmit a third signal to IP phone 20 so that the IP phone 20 completes the call forwarding configuration.

In the present embodiment, the third signal is also multi-frequency tone which carries the phone number of the IP phone 10. In the embodiment, if the IP phone 20 is otherwise able to forward the incoming call to the IP phone 10, the IP phone 20 must be aware of the phone number of the IP phone 10. FIG. 6 shows the transmitting of the third signal. The third signal carrying the phone number of the IP phone 10 is sent to the CM 40, and the CM 40 transfers the third signal to the IP phone 20, thus the IP phone 20 will receive the phone number of the IP phone 10 so that the IP phone 20 can actually carry out call forwarding from the IP phone 20 to the IP phone 10. In the embodiment, the phone number of the IP phone 10 is 7777.

While various embodiments and methods have been described above, it should be understood that they have been presented by way of example only and not by way of limitation. Thus the breadth and scope of the present disclosure should not be limited by the above-described embodiments, and should be at least commensurate with the following claims and their equivalents.

What is claimed is:

1. An Internet protocol phone, comprising at least one processor, a storage system, and one or more programs stored in the storage system and executed by the at least one processor, the one or more programs comprising instructions to:
detect a phone number of another Internet protocol phone;
transmit, from the Internet protocol phone to the detected Internet protocol phone, a first signal requesting the detected Internet protocol phone to enable a call forwarding mode;
transmit, from the Internet protocol phone to the detected Internet protocol phone, a second signal requesting confirmation that the detected Internet protocol phone has capabilities and has successfully enabled the call forwarding mode; and
transmit, from the Internet protocol phone to the detected Internet protocol phone, a third signal comprising a phone number of the Internet protocol phone, wherein the phone number can be used to forward a call to the detected Internet protocol phone to the Internet protocol phone.

2. The Internet protocol phone of claim 1, wherein the first signal is a series of alternative call demands and cancel demands.

3. The Internet protocol phone of claim 1, wherein both the second signal and the third signal are multi-frequency tones.

4. The Internet protocol phone of claim 1, wherein the second signal carries a security key, the detected Internet protocol phone permits the call forwarding setting from the Internet protocol phone upon condition that the detected Internet protocol phone can match the security key, and the detected Internet protocol phone does not permit the call forwarding setting from the Internet protocol phone upon condition that the detected Internet protocol phone cannot match the security key.

5. An Internet protocol phone, comprising at least one processor, a storage system, and one or more programs stored in the storage system and executed by the at least one processor, the one or more programs comprising instructions to:
receive, from another Internet protocol phone to the Internet protocol phone, a first signal requesting the Internet protocol phone to enable a call forwarding mode;
receive, from the another protocol phone to the Internet protocol phone, a second signal requesting confirmation that the Internet protocol phone has capabilities and has successfully enabled the call forwarding mode; and
receive, from the another Internet protocol phone to the Internet protocol phone, a third signal comprising a phone number of the Internet protocol phone, wherein the phone number can be used to forward a call to the Internet protocol phone to the another Internet protocol phone.

6. The Internet protocol phone of claim 5, wherein the first signal is a series of alternative call demands and cancel demands.

7. The Internet protocol phone of claim 5, wherein both the second signal and the third signal are multi-frequency tones.

8. The Internet protocol phone of claim 5, wherein the second signal carries a security key, the Internet protocol phone permits the call forwarding setting from the another Internet protocol phone upon condition that the Internet protocol phone can match the security key, and the Internet protocol phone does not permit the call forwarding setting from the Internet protocol phone upon condition that the Internet protocol phone can not match the security key.

9. A call forwarding method, applied in an Internet protocol phone, the method comprising:
detecting a phone number of another Internet protocol phone;
transmitting, from the Internet protocol phone to the detected Internet protocol phone, a first signal requesting the detected Internet protocol phone to enable call forwarding mode;
transmitting, from the Internet protocol phone to the detected Internet protocol phone, a second signal requesting confirmation that the detected Internet protocol phone has capabilities and has successfully enabled call forwarding mode; and
transmitting, from the Internet protocol phone to the detected Internet protocol phone, a third signal comprising a phone number of the Internet protocol phone to forward a call of the detected Internet protocol phone to the Internet protocol phone.

10. The method of claim 9, wherein the first signal is a series of alternative call demands and cancel demands.

11. The method of claim 9, wherein both the second signal and the third signal are multi-frequency tones.

12. The method of claim 9, wherein the second signal carries a security key, the detected Internet protocol phone permits the call forwarding setting from the Internet protocol phone upon condition that the detected Internet protocol phone can match the security key, and the detected Internet protocol phone does not permit the call forwarding setting from the Internet protocol phone upon condition that the detected Internet protocol phone cannot match the security key.

13. The method of claim 9, further comprising:
enabling the detected Internet protocol phone to call forwarding;
confirming that the detected Internet protocol phone has capabilities and has successfully enabled call forwarding mode;
receiving a phone number from the third Internet protocol phone; and
forwarding calls of the Internet protocol phone to the third Internet protocol phone according to the received phone number on condition that the detected Internet protocol phone has capabilities and has successfully enabled call forwarding mode.
